(19) United States
(12) Patent Application Publication
(10) Pub. No.: US 2025/0139759 A1
(43) Pub. Date: May 1, 2025

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: KOTA NAKAGAWA, Kanagawa (JP)

(21) Appl. No.: 18/915,592

(22) Filed: Oct. 15, 2024

(30) Foreign Application Priority Data
Oct. 30, 2023 (JP) 2023-185792

(51) Int. Cl. G06T 7/00; G06T 7/12; G06T 7/564; G06T 7/60

(52) U.S. Cl. CPC G06T 7/0008; G06T 7/001; G06T 7/12; G06T 7/564; G06T 7/60; G06T 2207/20076; G06T 2207/30108

(57) ABSTRACT

An image processing apparatus includes an obtaining unit configured to obtain a map representing a distribution of information related to protrusions and recesses based on a plurality of captured images obtained by imaging an inspection object, and a determination unit configured to determine presence/absence of a protrusion/recess defect in a boundary portion between an inspection region and a non-inspection region in the map based on a uniformity of the information in the boundary portion.

### CROSS-REFERENCE TO PRIORITY APPLICATION

This application claims the benefit of Japanese Patent Application No. 2023-185792, filed Oct. 30, 2023, which is hereby incorporated by reference herein in its entirety.

### BACKGROUND OF THE INVENTION

### Field of the Invention

The present invention relates to a technique for determining the presence or absence of a protrusion/recess defect in an inspection object.

### Description of the Related Art

As a technique for inspecting the appearance of an industrial product, a technique for detecting a defect on a surface (inspection surface) of an inspection target object is known. Japanese Patent Laid-Open No. 2003-240539 discloses a technique for determining a non-defective product/defective product based on whether an angular difference between a normal vector of an inspection object and a normal vector of a reference object exceeds a threshold.

Some industrial products are manufactured by pouring a fluid into a container and solidifying the fluid. In such industrial products, since interfacial tension acts between the container and the fluid, in regions near the walls of the container, a protruded/recessed shape is formed along the edges of the container. However, if there is a problem in the process of manufacturing, a protrusion/recess defect may occur in the protruded/recessed shape along the edges of the container. Therefore, an appearance inspection focusing on the protruded/recessed shape along the edges of the container is performed.

In such an inspection of the appearance of a surface having a protruded/recessed shape along the edges of a container, there is a need to detect a protrusion/recess defect in regions along the edges of the container while allowing a feature indicating the slope of an inclined surface along the edges of the container to vary depending on the individual. For example, there are cases where it is desired that even if the feature indicating the slope of an inclined surface varies depending on the individual in a protruded/recessed shape along the edges of a container, if the feature indicating the slope of the inclined surface is uniform in the individual, the individual be deemed a non-defective product, and if the slope of the inclined surface is non-uniform in the individual, the individual be be deemed a defective product.

However, in the technique described in Japanese Patent Laid-Open No. 2003-240539, a protrusion/recess defect is detected based on an angular difference between a normal vector of an inspection object and a normal vector of a reference object, and if the feature indicating the slope of an inclined surface along the edges of a container varies depending on the individual, the individual may be determined to be a defective product even when it is desired that the individual be deemed a non-defective product.

### SUMMARY OF THE INVENTION

The present invention provides a technique that makes it possible to determine the presence or absence of a protrusion/recess defect at a boundary portion between an inspection region and a non-inspection region while allowing a uniformity pertaining to protrusions and recesses at the boundary portion to vary depending on the individual.

According to the first aspect of the present disclosure, there is provided an image processing apparatus comprising: an obtaining unit configured to obtain a map representing a distribution of information related to protrusions and recesses based on a plurality of captured images obtained by imaging an inspection object; and a determination unit configured to determine presence/absence of a protrusion/recess defect in a boundary portion between an inspection region and a non-inspection region in the map based on a uniformity of the information in the boundary portion.

According to the second aspect of the present disclosure, there is provided an image processing method executed by an image processing apparatus, the method comprising: obtaining a map representing a distribution of information related to protrusions and recesses based on a plurality of captured images obtained by imaging an inspection object; and determining presence/absence of a protrusion/recess defect in a boundary portion between an inspection region and a non-inspection region in the map based on a uniformity of the information in the boundary portion.

According to the third aspect of the present disclosure, there is provided a non-transitory computer-readable storage medium storing a computer program that causes a computer to function as: an obtaining unit configured to obtain a map representing a distribution of information related to protrusions and recesses based on a plurality of captured images obtained by imaging an inspection object; and a determination unit configured to determine presence/absence of a protrusion/recess defect in a boundary portion between an inspection region and a non-inspection region in the map based on a uniformity of the information in the boundary portion.

Further features of the present invention will become apparent from the following description of exemplary embodiments with reference to the attached drawings.

### BRIEF DESCRIPTION OF THE DRAWINGS

FIG. 1 is a block diagram illustrating an example of a configuration of a system.

FIG. 2A is a diagram illustrating an example of the appearance of the system.

FIG. 2B is a bird's-eye view of a state in which an image capturing unit 1012 and light sources 0 to 7 included in an illumination unit 1013 are arranged.

FIG. 2C is a block diagram illustrating an example of a hardware configuration of the system.

FIGS. 3A to 3C are conceptual views illustrating a protrusion/recess defect along an edge of a container in an inspection object 204.

FIG. 4 is a flowchart of processing performed to determine the presence or absence of a protrusion/recess defect.

FIGS. 5A to 5C are diagrams illustrating processing for determining the presence or absence of a protrusion/recess defect in a protruded/recessed shape.

FIGS. 6A to 6C are diagrams for explaining a second variation.

FIG. 7 is a flowchart of processing performed to determine the presence or absence of a protrusion/recess defect.

FIG. 8 is a diagram illustrating an example of a result of calculating outliers for a defective product.

FIG. 9 is a flowchart of processing performed to determine the presence or absence of a protrusion/recess defect.

FIG. 10A is a plan view of a reference object.

FIG. 10B is a plan view of an inspection object.

FIG. 11 is a flowchart of processing performed to determine the presence or absence of a protrusion/recess defect.

FIG. 12 is a diagram illustrating how spatial filters are applied.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Example of Configuration of System

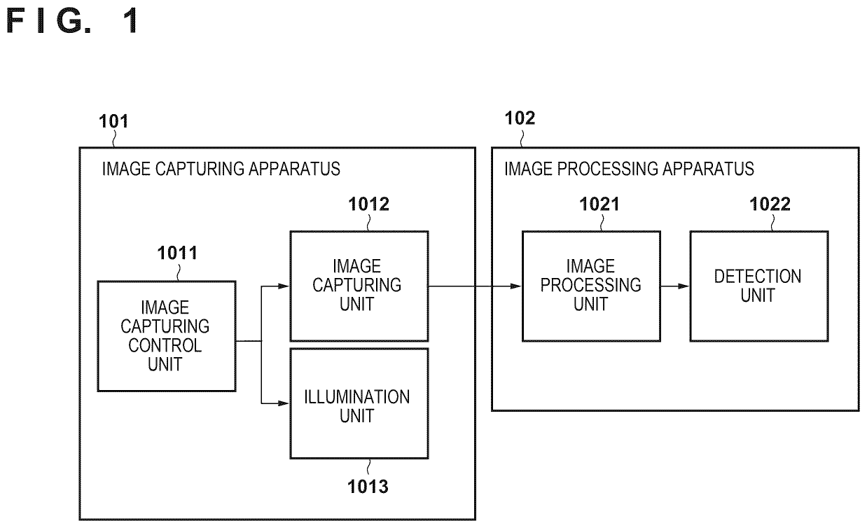

An example of a configuration of a system according to the present embodiment for inspecting the appearance of an inspection target object will be described with reference to a block diagram of FIG. 1. As illustrated in FIG. 1, the system according to the present embodiment includes an image capturing apparatus 101 and an image processing apparatus 102.

First, the image capturing apparatus 101 will be described. The image capturing apparatus 101 is an apparatus configured to image an inspection target object (inspection object), which is an object whose appearance is to be inspected, and includes an image capturing control unit 1011, an image capturing unit 1012, and an illumination unit 1013.

The image capturing unit 1012 is a two-dimensional image capturing apparatus and is, for example, a typical digital camera, a video camera, or an industrial camera. The illumination unit 1013 includes a plurality of light sources, each with a different arrangement position and illumination direction. The image capturing control unit 1011 controls the operation of the image capturing unit 1012 and the illumination unit 1013, such as a timing of image capturing by the image capturing unit 1012 and an emission timing of each light source in the illumination unit 1013.

Next, the image processing apparatus 102 will be described. The image processing apparatus 102 is an apparatus configured to inspect the appearance of an inspection object based on a plurality of captured images of the inspection object captured by the image capturing unit 1012 and includes an image processing unit 1021 and a detection unit 1022.

The image processing unit 1021 generates a feature map, which is a map pertaining to protrusions and recesses, based on a plurality of captured images of an inspection object captured by the image capturing unit 1012. The detection unit 1022 determines the presence or absence of a protrusion/recess defect at a boundary portion between an inspection region and a non-inspection region based on a uniformity of the feature map at the boundary portion in the feature map generated by the image processing unit 1021.

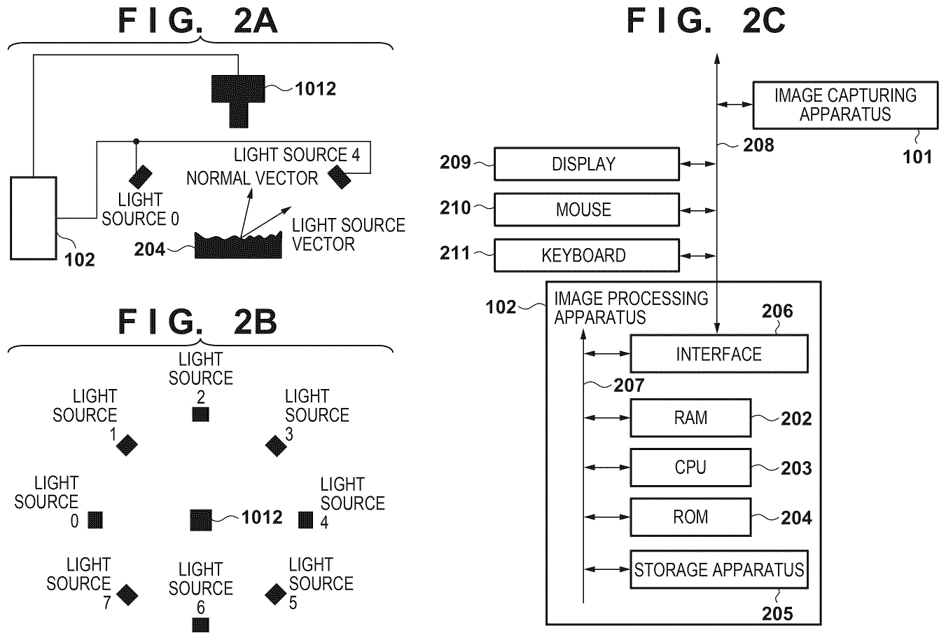

Next, an example of the appearance of the system according to the present embodiment will be described with reference to FIGS. 2A and 2B. FIG. 2A is a diagram illustrating an example of the appearance of the system according to the present embodiment, and FIG. 2B is a bird's-eye view of a state in which the image capturing unit 1012 and light sources 0 to 7 included in the illumination unit 1013 are arranged.

The image capturing unit 1012 is positioned directly over an inspection object 204 with an image capturing direction directed toward the inspection object 204, as illustrated in FIG. 2A, for example, so as to image the appearance of the inspection object 204. The light sources in the illumination unit 1013 are arranged in a manner in which they surround the inspection object 204, as illustrated in FIGS. 2A and 2B, for example, so as to irradiate the inspection object 204 with light from various directions, and thus, the illumination unit 1013 constitutes a dome-shaped multi-light illumination.

In such a configuration, the image capturing apparatus 101 sequentially performs the following operations for i=0 to 7. The image capturing control unit 1011 outputs a light emission instruction (light emission instruction i) for causing a light source i to emit light to the illumination unit 1013, and the illumination unit 1013 causes the light source i to emit light in response to the light emission instruction i. The image capturing control unit 1011 outputs an image capturing instruction to the image capturing unit 1012, and the image capturing unit 1012 captures a still image (captured image) of the inspection object 204 in response to the image capturing instruction and outputs the captured image to the image processing apparatus 102. Thus, the image processing apparatus 102 obtains the captured image of the inspection object 204 irradiated with light by the light source i. Then, the image capturing control unit 1011 outputs a turn-off instruction (turn-off instruction i) for turning off the light source i to the illumination unit 1013, and the illumination unit 1013 causes the light source i to turn off in response to the turn-off instruction i.

The configuration of the image capturing apparatus 101 described above is only one example of a configuration for obtaining captured images of the inspection object 204 irradiated with light by a respective one of the plurality of light sources with different arrangement positions and light irradiation directions. Therefore, the arrangement positions, the light irradiation directions, the number, and the like of the light sources are not limited to the above configuration (the number of light sources may be 3 or more).

Next, an example of a hardware configuration of the system according to the present embodiment will be described with reference to a block diagram of FIG. 2C. A CPU 203 executes various kinds of processing using computer programs and data stored in a RAM 202. Thus, the CPU 203 controls the operation of the entire image processing apparatus 102 and executes or controls various kinds of processing described as processing to be performed by the image processing apparatus 102.

The RAM 202 includes an area for storing computer programs and data loaded from a ROM 204 or a storage apparatus 205 and an area for storing various kinds of information (captured images, etc.) outputted from the image capturing apparatus 101 through an interface 206. Further, the RAM 202 includes a work area that the CPU 203 uses when performing various kinds of processing. In this way, the RAM 202 can provide various areas as appropriate.

The ROM 204 stores setting data of the image processing apparatus 102, computer programs and data for activating the image processing apparatus 102, computer programs and data for basic operations of the image processing apparatus 102, and the like.

The storage apparatus 205 is a non-volatile memory apparatus such as a hard disk drive apparatus. The storage apparatus 205 stores an OS, computer programs and data for causing the CPU 203 to execute or control various kinds of processing described as processing to be performed by the image processing apparatus 102, and the like. The computer programs stored in the storage apparatus 205 include a computer program for causing the CPU 203 to execute the functions of the image processing unit 1021 and the detection unit 1022. In the following, the image processing unit 1021 or the detection unit 1022 may be described as a performer of the processing, but in practice, the functions of the corresponding functional units are realized by the CPU 203 executing a computer program corresponding to the image processing unit 1021 and the detection unit 1022. The image processing unit 1021 and the detection unit 1022 may be implemented by hardware.

An external bus 208 is connected to the interface 206. A display 209, a mouse 210, a keyboard 211, and the image capturing apparatus 101 are connected to the external bus 208.

The display 209 is an apparatus including a liquid crystal screen or a touch panel screen and can display a result of processing by the CPU 203 with images, characters, and the like. The display 209 may be a projection apparatus such as a projector for projecting images and characters.

The keyboard 211 and the mouse 210 are examples of a user interface, and by operating these, the user can input various kinds of instructions and information to the image processing apparatus 102.

### Confirmation of Problems of Present Embodiment

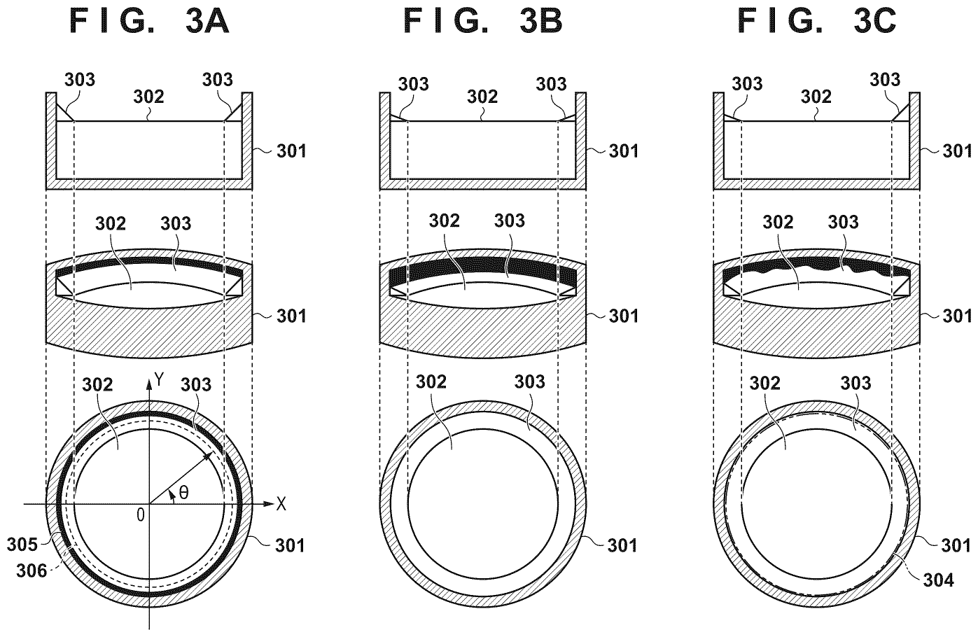

In inspection of the appearance of a surface having a protruded/recessed shape along a boundary between an inspection region and a non-inspection region, there is a need to detect a protrusion/recess defect in a region along the boundary while allowing the slopes of an inclined surface along the boundary to vary depending on the individual. Here, the boundary between the inspection region and the non-inspection region may be a protruded/recessed shape formed along the edge of a container due to interfacial tension between content and the container at a surface of an industrial product manufactured by pouring the content into the container and solidifying the content. Further, the boundary between the inspection region and the non-inspection region may be a region in which there is an inclined surface in a protruded shape formed by embossing or in a recessed shape formed by debossing. FIGS. 3A to 3C illustrate examples of an inspection object in appearance inspection with such a need. In FIGS. 3A to 3C, cross-sectional views are at the top, perspective views are in the middle, and plan views are at the bottom.

An inspection object illustrated in FIGS. 3A to 3C is an industrial product manufactured by pouring a fluid into a container 301 and solidifying the fluid. When the fluid is poured into the container 301, since interfacial tension acts between the container 301 and the fluid, a protruded/recessed shape 303 is formed along an edge 305 of a container in a region near the wall of the container 301. For the sake of explanation, the edge 305 of the container is illustrated only in the plan view at the bottom of FIG. 3A. Meanwhile, a surface 302 near the center of the container 301 is substantially flat. In the present embodiment, as illustrated in FIGS. 3A to 3C, a surface having the protruded/recessed shape 303 along the boundary between the inspection region and the non-inspection region is assumed as an inspection target. In the present embodiment, the purpose is to determine the presence or absence of a protrusion/recess defect, particularly in the protruded/recessed shape 303 along the boundary of the inspection region and the non-inspection region.

At this time, there is a need to allow the slope of the inclined surface along the boundary between the inspection region and the non-inspection region to vary depending on the individual. For example, in the inspection object of FIG. 3A and the inspection object of FIG. 3B, the slope of the inclined surface of the protruded/recessed shape 303 is different. However, in the inspection object of FIG. 3A and the inspection object of FIG. 3B, the slope of the inclined surface of the protruded/recessed shape 303 along the boundary between the inspection region and the non-inspection region, that is, the edge of the container 301, is uniform. Therefore, it is desired that it be determined that both the inspection object of FIG. 3A and the inspection object of FIG. 3B do not have a protrusion/recess defect.

Meanwhile, in the inspection object of FIG. 3C, the slope of the inclined surface of the protruded/recessed shape 303 along the boundary between the inspection region and the non-inspection region, that is, the edge of the container 301, is non-uniform. The cross-sectional view at the top of FIG. 3C illustrates a state in which the height of the protruded/recessed shape 303 is greater on the right side than on the left side and the slope of the inclined surface of the protruded/recessed shape 303 is greater on the right than on the left side. The plan view at the bottom of FIG. 3C illustrates a state in which such a protrusion/recess defect 304 has appeared on the inclined surface of the protruded/recessed shape 303 along the edge of the container 301. Therefore, it is desired that it be determined that the inspection object of FIG. 3C has a protrusion/recess defect. The protrusion/recess defect 304 is indicated by a dashed line along the edge of the container for the sake of explanation but, in practice, extends to regions inside the dashed line (region of the inclined surface of the protruded/recessed shape 303).

At this time, in the technique described in Japanese Patent Laid-Open No. 2003-240539, a protrusion/recess defect is detected based on an angular difference between a normal vector of an inspection object and a normal vector of a reference object. Therefore, in the protruded/recessed shape 303 along the boundary between the inspection region and the non-inspection region, if the inspection object of FIG. 3A is set as a reference object, it can be determined that the inspection object of FIG. 3C has a protrusion/recess defect. That is, in the inspection object of FIG. 3A, the slope of the inclined surface of the protruded/recessed shape 303 along the edge of the container 301 is uniform. Meanwhile, in the inspection object of FIG. 3C, the slope of the inclined surface of the protruded/recessed shape 303 along the edge of the container 301 is non-uniform. Therefore, if the inspection object of FIG. 3A is set as a reference object, it can be determined that the inspection object of FIG. 3C has a protrusion/recess defect.

However, in the technique described in Japanese Patent Laid-Open No. 2003-240539, when the slope of the inclined surface along the edge of the container 301 varies depending on the individual as in the example illustrated in FIGS. 3A and 3B, the individual is determined to be a defective product even if it is a non-defective product. That is, if the inspection object of FIG. 3A is set as a reference object, since the inspection object of FIG. 3B is different from the inspection object of FIG. 3A in the slope of the inclined surface of the protruded/recessed shape 303, it is determined that there is a defect.

Therefore, in the present embodiment, the purpose is to detect, in inspection of the appearance of a surface having a protruded/recessed shape along the boundary between the inspection region and the non-inspection region, a protrusion/recess defect while allowing the slope of the inclined surface along the boundary to vary depending on the individual as in FIGS. 3A and 3B.

The inspection target, that is, a target for which the presence or absence of a protrusion/recess defect is determined is not limited to the protruded/recessed shape 303 along the edge of the container 301. For example, a protruded/recessed shape such as a pattern or text may be formed on the surface 302 by embossing or debossing. In embossing, a protruded shape is formed on the surface. In debossing, a recessed shape is formed on the surface. At this time, since a protruded/recessed shape such as a pattern or text is constituted by a combination of straight lines and curves, these are a protruded/recessed shape along the boundary between the inspection region and the non-inspection region. Even in such a protruded/recessed shape along the boundary between the inspection region and the non-inspection region that is formed by embossing or debossing, there is a need to detect a protrusion/recess defect while allowing the slope of the inclined surface along the edge of the container 301 to vary depending on the individual. Therefore, in the present embodiment, a protruded shape formed by embossing or a recessed shape formed by debossing is also an inspection target, that is, a target for which the presence or absence of a protrusion/recess defect is determined.

### Example of Operation of System

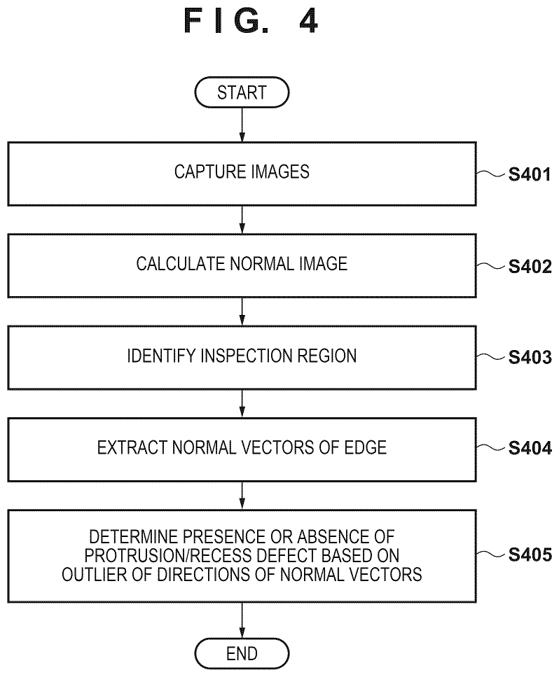

Next, the processing performed to determine the presence or absence of a protrusion/recess defect, according to the system according to the present embodiment, will be described according to the flowchart of FIG. 4. In step S401, the image capturing control unit 1011 controls the image capturing unit 1012 and the illumination unit 1013 as described above. Thus, the image capturing apparatus 101 causes respective light sources to sequentially emit light and images an inspection surface of the inspection object 204 and outputs a plurality of captured images obtained by the imaging to the image processing apparatus 102.

The inspection surface of the inspection object 204 is a surface of the inspection object 204 and includes the protruded/recessed shape along the boundary between the inspection region and the non-inspection region. In the example of FIGS. 3A to 3C, the inspection surface of the inspection object 204 corresponds to the protruded/recessed shape 303 and the surface 302. At this time, the captured images obtained from the image capturing apparatus 101 are images such as the plan views illustrated at the bottom of FIGS. 3A to 3C.

Next, in step S402, the image processing unit 1021 generates (calculates) a feature map, which is a map pertaining to protrusions/recesses, from the plurality of captured images obtained from the image capturing apparatus 101. The feature map is a map such as a normal map indicating a distribution of normal vectors at respective positions on the inspection surface of the inspection object 204, a height map indicating a distribution of heights at respective positions on the inspection surface, and a luminance map indicating a distribution of luminances at respective positions on the inspection surface.

In the present embodiment, the image processing unit 1021 generates a normal map (normal image) representing normal vectors at respective positions on the inspection surface of the inspection object 204 as a feature map of the inspection surface of the inspection object 204. At each pixel position of the normal image, component data of a normal vector at a position in real space corresponding to that pixel position is stored. The component data is data of three channels; the first channel stores an x component of the normal vector, the second channel stores a y component of the normal vector, the third channel stores a z component of the normal vector.

The image processing unit 1021, for example, generates a normal image from the plurality of captured images using a photometric stereo method. For example, the image processing unit 1021 generates a normal image using a method disclosed in Japanese Patent Laid-Open No. 2016-186421. The method for generating a normal image is not limited to a specific method, and for example, the image processing unit 1021 may obtain shape information of the inspection surface with a light-section method and generate a normal image based on the obtained shape information.

Next, in step S403, the image processing unit 1021 identifies an inspection region from the normal image. In the example of FIGS. 3A to 3C, the image processing unit 1021 identifies a region corresponding to the inspection surface (surface 302 and protruded/recessed shape 303) in the normal image as the inspection region. The method for identifying an inspection region in a normal image is not limited to a specific method.

For example, the image processing unit 1021 first identifies a region corresponding to the inspection surface (surface 302 and protruded/recessed shape 303) in a captured image as a target region. Various methods are conceivable as the method for identifying a target region in a captured image. For example, the image processing unit 1021 identifies a region having a hue, saturation, or brightness of the content as a target region in a captured image obtained by imaging the inspection object 204 from where it is closer to the zenith. Then, the image processing unit 1021 identifies a corresponding region corresponding to the target region in the normal image as the inspection region. The image processing unit 1021 may identify a region of the content using semantic segmentation in which deep learning is used or may detect the boundary between the content and the container as an edge through image processing.

Further, the image processing unit 1021 identifies the remaining regions other than the inspection region in the normal image as a non-inspection region.

Next, in step S404, the detection unit 1022 sets a region (boundary portion) having a predetermined width (width of one or more pixel) along the boundary between the inspection region and the non-inspection region as a first inspection region in the normal image. For example, the detection unit 1022 identifies a difference region between a reduced target region, obtained by reducing the target region in a captured image obtained by imaging the inspection object 204 from where it is close to the zenith by a prescribed reduction ratio, and the target region and sets a corresponding region corresponding to the difference region as the first inspection region in the normal image. The detection unit 1022 may set a difference region between a reduced inspection region, obtained by reducing the inspection region in the normal image at a prescribed reduction ratio, and the inspection region as the first inspection region. By setting the above “prescribed width” to “one pixel”, it is possible to set the outermost pixel group of the inspection region as the first inspection region. The detection unit 1022 arranges the pixel group in the first inspection region along a shape in which they were extracted. The detection unit 1022 can also extract a region (pixel group) having a prescribed width according to the size of a filter in the reduction processing described above. In that case, the inner side of the inspection region is smaller, and thus, it is necessary to resize the inspection region. The method of setting the first inspection region is not limited to a specific setting method.

In step S405 to be described later, the detection unit 1022 determines the presence or absence of a protrusion/recess defect in the protruded/recessed shape based on the slope of the inclined surface of the protruded/recessed shape. In the example of FIGS. 3A to 3C, the detection unit 1022 determines the presence or absence of a protrusion/recess defect in the protruded/recessed shape 303. In the following, a case where a line-shaped region 306 along the edge 305 of the container is assumed as the first inspection region will be described. In this case, the detection unit 1022 detects the edge 305 of the container by applying a known edge detection processing on a captured image obtained by imaging the inspection object 204 from where it is close to the zenith and sets the line-shaped region 306 within a certain distance from the edge 305 of the container as the first inspection region. The line-shaped region 306 is included in the inclined surface of the protruded/recessed shape 303. In step S405, to be described later, the detection unit 1022 determines the presence or absence of a protrusion/recess defect in the protruded/recessed shape based on the slope of the inclined surface in the line-shaped region 306. Specifically, the detection unit 1022, if the slope of the inclined surface of the protruded/recessed shape is uniform in the first inspection region (line-shaped region 306), determines that there is no defect and, if the slope of the inclined surface of the protruded/recessed shape is non-uniform in the first inspection region (line-shaped region 306), determines that there is a defect.

If the position of the inspection object 204 does not change, or if the position of the inspection object has been identified, the detection unit 1022 need not perform edge detection, and a preset region may be set as the first inspection region. The first inspection region is not limited to a line-shaped region and may be set as a band-shaped region. Further, when detecting a protrusion/recess defect in a line-shaped protruded shape formed by embossing and when detecting a protrusion/recess defect in a line-shaped recessed shape formed by debossing, a region along the boundary between the inspection region and the non-inspection region is set as the first inspection region according to a similar method.

Then, in step S404, the detection unit 1022 further obtains component data of each pixel constituting the first inspection region in the normal image. As illustrated in the plan view at the bottom of FIG. 3A, an x-axis and a y-axis are set on the inspection surface of the inspection object 204, the inspection surface is set as an xy plane, and a z-axis is set in a direction perpendicular to the inspection surface. The inspection surface of the inspection object 204 is a surface that is based on the inspection object 204 and, for example, may be a surface on which the inspection object 204 is placed or may be the surface 302. At this time, each position in the line-shaped region 306 can be represented by an angle θ relative to the x-axis. Therefore, when component data at a position (x, y) is set as n (x, y), the component data can be expressed as n(θ) with the angle θ as an argument.

Next, in step S405, the detection unit 1022 determines a uniformity pertaining to the slope in the first inspection region based on the respective pieces of component data obtained in step S404 and, based on a result of the determination, determines the presence or absence of a protrusion/recess defect in the protruded/recessed shape.

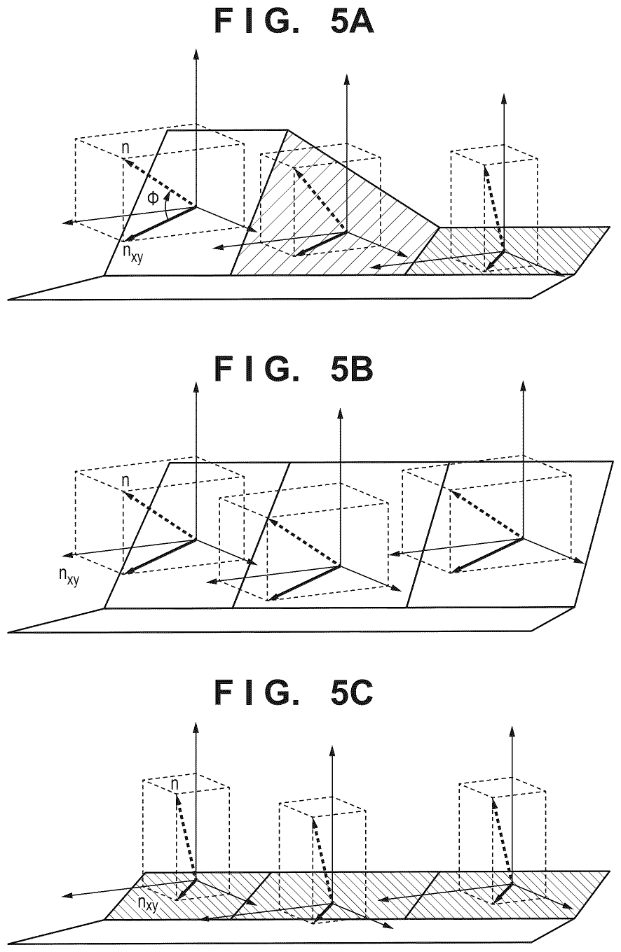

The processing for determining the presence or absence of a protrusion/recess defect in the protruded/recessed shape based a result of determination of a uniformity pertaining to the slope in the first inspection region will be described using FIGS. 5A to 5C as an example. In FIGS. 5A to 5C, dashed-line arrows are normal vectors n represented by respective pieces of component data n(θ) of three pixels in the first inspection region. The normal vectors n are normalized to have a length of 1.

In the present embodiment, the detection unit 1022 determines the presence or absence of a protrusion/recess defect in the protruded/recessed shape based on an outlier of normal vectors. Specifically, the detection unit 1022 determines the presence or absence of a protrusion/recess defect in the protruded/recessed shape based on the presence or absence of an outlier of directions of the normal vectors. As a direction of a normal vector, for example, an angle φ of a normal vector n relative to the xy plane is used. In FIGS. 5A to 5C, nxy is a projected vector obtained by projecting the normal vector n onto the xy plane. The angle φ is an angle of the normal vector n relative to the vector nxy. The angle φ can be calculated from the normal vector n and is a function of the position θ in the first inspection region and is thus denoted as φ(θ). This function φ(θ) is a function indicating the slope (angle of slope) of the inclined surface at a respective position θ of the first inspection region. As illustrated in FIGS. 5B and 5C, if the slope of the inclined surface is uniform irrespective of the change of the position θ, the values of the function φ(θ) are constant for the positions θ. FIG. 5B corresponds to FIG. 3A, and FIG. 5C corresponds to FIG. 3B. Meanwhile, as illustrated in FIG. 5A, if the slope of inclined surface is not uniform (non-uniform) depending on the position θ, the values of the function φ(θ) are not constant and varies depending on the position θ. FIG. 5A corresponds to FIG. 3C. Therefore, by detecting an outlier of the function φ(θ) in the first inspection region, the detection unit 1022 determines the presence or absence of a protrusion/recess defect in the protruded/recessed shape.

For example, the detection unit 1022 obtains an average value of the values of the function φ(θ) at respective positions θ and, by subtracting the average value from the value of the function φ(θ) at each position θ, removes a DC component of the value of the function φ(θ). In order to remove the DC component, the detection unit 1022 may apply one-dimensional spatial filters (e.g., DoG filters), the sum of whose coefficients is zero, on the value of the function φ(θ) at each position θ.

Then, the detection unit 1022 compares the magnitudes of the DC component-removed value of the function φ(θ) at each position θ and thresholds. In this case, a positive threshold and a negative threshold are set as the thresholds. Then, if there is a value exceeding the positive threshold among the DC component-removed values of the function φ(θ) at respective positions θ, the detection unit 1022 determines that “there is an outlier”. Similarly, if there is a value falling below the negative threshold among the DC component-removed values of the function φ(θ) at respective positions θ, the detection unit 1022 determines that “there is an outlier”. If neither a value exceeding the positive threshold nor a value falling below the negative threshold is included in the DC component-removed values of the function φ(θ) at respective positions θ, the detection unit 1022 determines that “there is no outlier”. Various methods can be applied to the method for determining the presence or absence of an outlier of DC component-removed values of the function φ(θ) at respective positions θ, and the method is not limited to the above method.

Then, the detection unit 1022, if it is determined that “there is an outlier”, determines that “there is a protrusion/recess defect in the protruded/recessed shape” and, if it is determined that “there is no outlier”, determines that “there is no protrusion/recess defect in the protruded/recessed shape”.

The detection unit 1022 outputs a result of the determination. There are various output methods for the method of outputting a result of the determination, and the method is not limited to a specific output method. For example, the detection unit 1022 may cause the display 209 to display a message representing the presence or absence of a protrusion/recess defect in the protruded/recessed shape with an image and/or text or may transmit such a message to an external apparatus via a network. Further, for example, if there is an outlier, the detection unit 1022 may display a marker or the like at a position corresponding to the position θ deemed to be an outlier in a superimposed manner in a captured image obtained by imaging the inspection object 204 from the vicinity of the zenith. Thus, so long as it is possible to notify the user of the presence or absence of a protrusion/recess defect in the protruded/recessed shape, the method is not limited to a specific method.

Further, in the present embodiment, if even one of the DC component-removed values of the function φ(θ) at respective positions θ exceeds the positive threshold or falls below the negative threshold, it is determined that “there is a protrusion/recess defect in the protruded/recessed shape”. However, configuration may be taken such that if the number of values exceeding the positive threshold or falling below the negative threshold among the DC component-removed values of the function φ(θ) at respective positions θ is a prescribed number or more, it is determined that “there is a protrusion/recess defect in the protruded/recessed shape”, and if the number is less than the prescribed number, it is determined that “there is no protrusion/recess defect in the protruded/recessed shape”.

### Effects of First Embodiment

Thus, in the present embodiment, if the function φ(θ) indicating the slope of the inclined surface in the protruded/recessed shape is uniform in the first inspection region (line-shaped region 306), it is determined that there is no defect. Therefore, even if the slope of the inclined surface along the first inspection region is different depending on the individual as in FIGS. 3A and 3B, it can be determined that they both do not have a defect. Meanwhile, in the present embodiment, if the values of the function φ(θ) indicating the slope of the inclined surface in the protruded/recessed shape are non-uniform in the first inspection region (line-shaped region 306), it is determined that there is a defect. Therefore, if the slope of the inclined surface changes depending on the position θ as in FIG. 3C, it can be determined that there is a defect.

That is, according to the present embodiment, it is possible to detect, in inspection of the appearance of a surface having a protruded/recessed shape along the boundary between the inspection region and the non-inspection region, a protrusion/recess defect in the region along the boundary while allowing the slope of the inclined surface along the boundary to vary depending on the individual.

In the following, a plurality of variations of the first embodiment will be described, but in these variations, only differences from the first embodiment will be described, and unless otherwise mentioned, it is assumed that the variations are similar to the first embodiment.

### First Variation

The angle φ indicating the slope of the inclined surface of the protruded/recessed shape 303 is cos⁻¹(|nxy|/|n|) as can be seen from FIGS. 5A to 5C. nxy is a projected vector obtained by projecting the normal vector n onto the inspection plane (xy plane). |nxy| indicates the length of nxy. |n| indicates the length of the normal vector n. As described above, the normal vectors n are normalized to have a length of 1. Therefore, the angle φ is cos⁻¹(|nxy|). That is, the angle φ is uniquely determined from |nxy|. More specifically, the angle φ monotonically decreases as |nxy| increases. Therefore, when determining the presence or absence of a protrusion/recess defect in the protruded/recessed shape 303, instead of detecting an outlier of the angles φ, an outlier of the lengths |nxy| of the projected vectors obtained by projecting the normal vectors n onto the inspection surface (xy plane) may be detected. In that case, if the slope of the inclined surface is uniform irrespective of the position θ as in FIGS. 5B and 5C, the lengths |nxy| will be uniform irrespective of the location, and an outlier will not be detected, and so, it can be determined that there is no defect. Meanwhile, if the slope of the inclined surface is non-uniform depending on the position θ as in FIG. 5A, the lengths |nxy| will be non-uniform depending on the location, and an outlier will be detected, and so, it can be determined that there is a defect.

### Second Variation

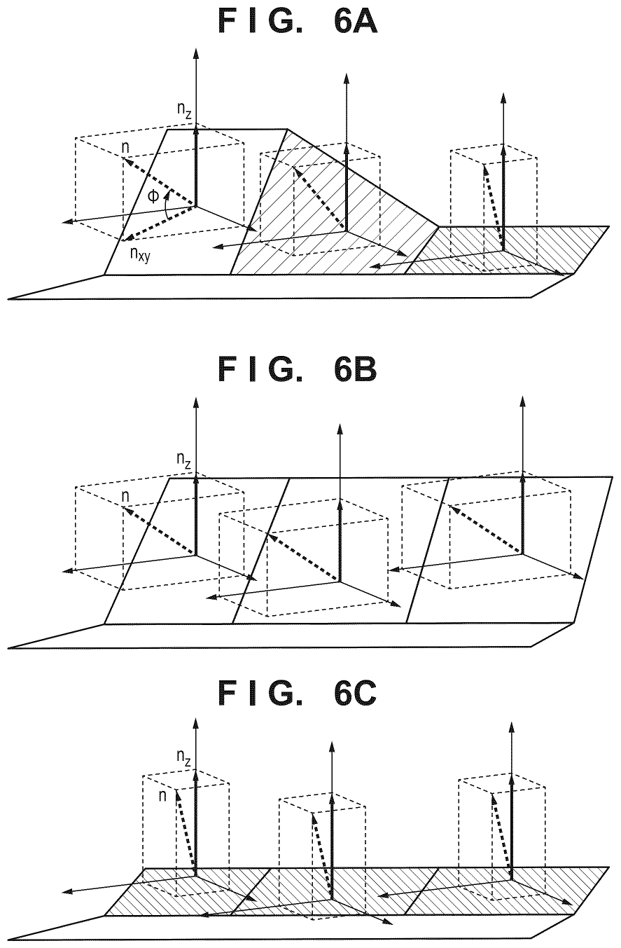

FIGS. 6A to 6C correspond to FIGS. 5A to 5C, respectively. In FIGS. 6A to 6C, nz indicates a projected vector obtained by projecting a normal vector n in a direction (z-axis) perpendicular to the inspection surface. In FIGS. 6A to 6C, the normal vectors nz are indicated by solid-line arrows. Meanwhile, the normal vectors n and the projected vectors nxy obtained by projecting the normal vectors n onto the inspection plane (xy plane) are indicated by dashed-line arrows. As illustrated in FIGS. 6A to 6C, the angle φ indicating the slope of the inclined surface of the protruded/recessed shape 303 is sin⁻¹(|nz|/|n|). |nz| indicates the length of a normal vector nz and is the value of a z component of the normal vector n. As described above, the normal vectors n are normalized to have a length of 1. Therefore, the angle φ is sin⁻¹(|nz|). That is, the angle φ is uniquely determined from |nz|. More specifically, the angle φ monotonically increases as |nz| increases. Therefore, when determining the presence or absence of a protrusion/recess defect in the protruded/recessed shape 303, instead of detecting an outlier of the angles φ, an outlier of the lengths |nz| of the projected vectors obtained by projecting the normal vectors n in a direction (z-axis) perpendicular to the inspection surface may be detected. In that case, if the slope of the inclined surface is uniform irrespective of the position θ as in FIGS. 6B and 6C, |nz| will be uniform irrespective of the position θ, and an outlier will not be detected, and so, it can be determined that there is no defect. Meanwhile, if the slope of the inclined surface is non-uniform depending on the position θ as in FIG. 6A, |nz| will be non-uniform depending on the position θ, and an outlier will be detected, and so, it can be determined that there is a defect.

### Third Variation

In the present variation, a luminance map is used as a feature map. The luminance map is an image indicating a distribution of luminances at the inspection surface of the inspection object 204. Since the distribution of luminances at the inspection surface reflects a distribution of normal vectors at the inspection surface, even if an outlier of pixel values in the luminance map are detected instead of detecting an outlier of normal vectors, it is possible to determine the presence or absence of a protrusion/recess defect.

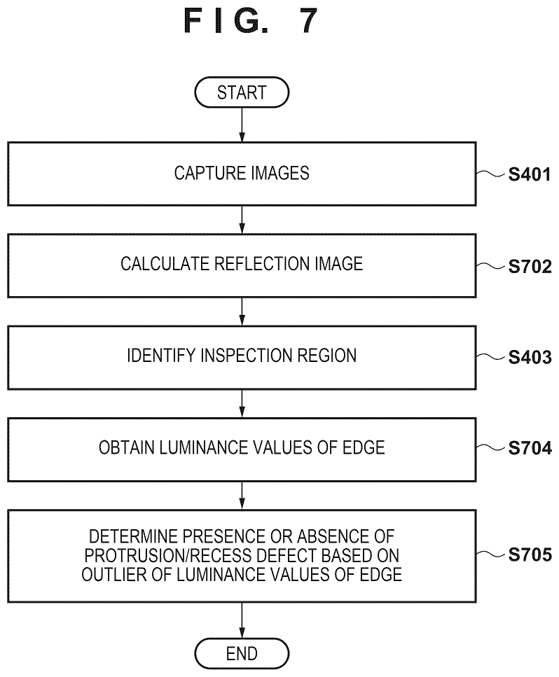

The processing performed to determine the presence or absence of a protrusion/recess defect, according to the system according to the present variation, will be described according to the flowchart of FIG. 7. In FIG. 7, the same processing steps as those of FIG. 4 are denoted by the same step numerals, and the description pertaining to these processing steps will be omitted.

In step S702, the image processing unit 1021 obtains a luminance map as a feature map from the plurality of captured images obtained from the image capturing apparatus 101. In the present embodiment, the image processing unit 1021 obtains a reflection image as the luminance map. The reflection image is a maximum value image generated by extracting the maximum pixel value for each pixel position from the plurality of captured images obtained by causing light sources, each at a different position, to sequentially emit light and performing image capturing. If the captured image group is RGB images, a reflection image is generated using the pixel value of a G channel, for example. That is, the pixel value at a pixel position (x, y) in the reflection image is the maximum pixel value among the pixel values of the G channel at the pixel position (x, y) of each of the plurality of captured images.

The image processing unit 1021 may generate (calculate) an average value image as the luminance map. The average value image is an image generated by calculating an average value of pixel values for each pixel position from the plurality of captured images obtained by causing light sources, each at a different position, to sequentially emit light and performing image capturing. That is, the pixel value at a pixel position (x, y) in the average value image is an average value of pixel values at the pixel position (x, y) of each of the plurality of captured images.

Further, the image processing unit 1021 may select (obtain), from a plurality of captured images obtained by causing light sources, each at a different position, to sequentially emit light and performing image capturing, a captured image containing the greatest amount of specularly reflected light from a light source as the luminance map. For example, when the image capturing unit 1012 at the apex of the dome-shaped multi-light illumination is installed as illustrated in FIG. 2B, an image captured by lighting a light source at a position closest to the image capturing unit 1012 includes the greatest amount of specularly reflected light of the light source. Therefore, in this case, the image processing unit 1021 selects an image captured by lighting a light source at a position closest to the image capturing unit 1012 as the luminance map.

In step S403 according to the present variation, the image processing unit 1021 identifies an inspection region from the reflection image using, for example, a method similar to that of the first embodiment, and identifies the remaining regions other than the inspection region as a non-inspection region in the reflection image.

In step S704, the detection unit 1022 sets the first inspection region in the reflection image as in step S404 described above and obtains the pixel value (luminance value) of each pixel constituting the first inspection region in the reflection image. When the pixel value at the pixel position (x, y) in the reflection image is set as i(x, y), the pixel value can be expressed as i(θ) with the angle θ as an argument.

In step S705, the detection unit 1022 determines the presence or absence of an outlier for the pixel values obtained in step S704. For example, the detection unit 1022 obtains an average value of the pixel values obtained in step S704. Then, if there is a pixel value separated from the average value by a prescribed value or more among the pixel values obtained in step S704, the detection unit 1022 determines that “there is an outlier”. Meanwhile, if there is no pixel value separated from the average value by the prescribed value or more among the pixel values obtained in step S704, the detection unit 1022 determines that “there is no outlier”.

Then, the detection unit 1022, if it is determined that “there is an outlier”, determines that “there is a protrusion/recess defect in the protruded/recessed shape” and, if it is determined that “there is no outlier”, determines that “there is no protrusion/recess defect in the protruded/recessed shape”.

As described above, even if an outlier in the luminance map is used instead of an outlier in the normal image, it is possible to detect a protrusion/recess defect in a region along the first inspection region while allowing the slope of the inclined surface along the first inspection region to vary depending on the individual.

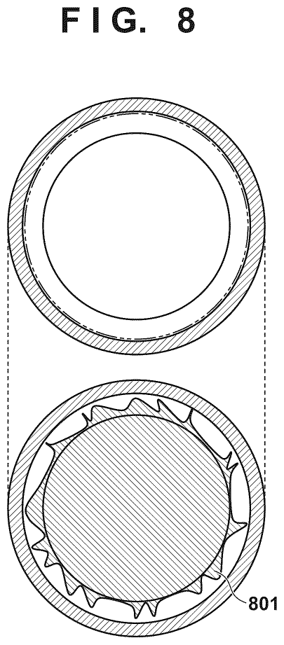

FIG. 8 illustrates an example of a result of calculating outliers for a defective product. When values above a certain threshold are displayed in the reflection image, a region 801 in which there is a protrusion/recess defect remains. Since the values at the coordinates of the remaining region 801, which includes specular reflection components, are outliers themselves, a sum for the above region is obtained, and by confirming whether the sum exceeds a threshold, it is possible to determine whether the product is a non-defective product or a defective product. With the above processing, it is possible to identify the location and size of a protrusion/recess defect.

### Fourth Variation

In the present variation, in addition to the inspection of a protruded/recessed shape along the first inspection region, another region at the inspection surface is inspected. As described above, in a protruded/recessed shape (e.g., protruded/recessed shape 303) along the boundary between the inspection region and the non-inspection region, there is a need to allow that the slope of the inclined surface along the first inspection region varies depending on the individual. Meanwhile, in another region (e.g., surface 302) at the inspection surface, there is a need to detect protrusions and recesses outside of a reference range as a protrusion/recess defect without allowing the shape or the inclined surface to vary depending on the individual. In the present variation, the presence or absence of a protrusion/recess defect is determined using a different method for each region. The present variation differs from the first embodiment in that that the processing to be described below is performed in steps S404 and S405 in the flowchart of FIG. 4.

In step S404, the detection unit 1022 sets the first inspection region in the normal image as in the first embodiment and sets, as a second inspection region, a region (e.g., surface 302) not included in the first inspection region in the normal image.

In step S405, the detection unit 1022 determines the presence or absence of a protrusion/recess defect in the first inspection region as in the first embodiment. Further, the detection unit 1022 determines a uniformity according to a slope in the second inspection region and, based on a result of the determination, determines the presence or absence of a protrusion/recess defect in the second inspection region. Specifically, the detection unit 1022, if the slope of an inclined surface in the second inspection region is within the reference range, determines that there is no defect and, if the slope of the inclined surface in the second inspection region is not within the reference range, determines that there is a defect. As a method of this determination, for example, a method described in Japanese Patent Laid-Open No. 2003-240539 is used. Specifically, the detection unit 1022 obtains angular differences between normal vectors of the inspection object and normal vectors of the reference object in the second inspection region. Then, the detection unit 1022, if the sum of the angular differences is greater than or equal to a threshold, determines that “there is a protrusion/recess defect in the second inspection region” and, if the sum of the angular differences is less than the threshold, determines that “there is no protrusion/recess defect in the second inspection region”.

Thus, in the second inspection region, it is possible to detect protrusions and recesses outside of the reference range as a protrusion/recess defect without allowing the shape or the inclined surface to vary depending on the individual. Thus, according to the fourth variation, it is possible perform protrusion/recess inspection from a different standpoint for each region.

### Second Embodiment

In the present embodiment, only differences from the first embodiment will be described, and the present embodiment is assumed to be similar to the first embodiment unless otherwise mentioned. In the present embodiment, detection of a protrusion/recess defect is performed using a reference object for comparison with the inspection object. Also in the present embodiment, a protrusion/recess defect in a region along the first inspection region is detected while allowing the slope of the inclined surface along the first inspection region to vary depending on the individual. That is, it is necessary to incorporate a mechanism that does not reflect individual differences between non-defective products when deciding on a reference object.

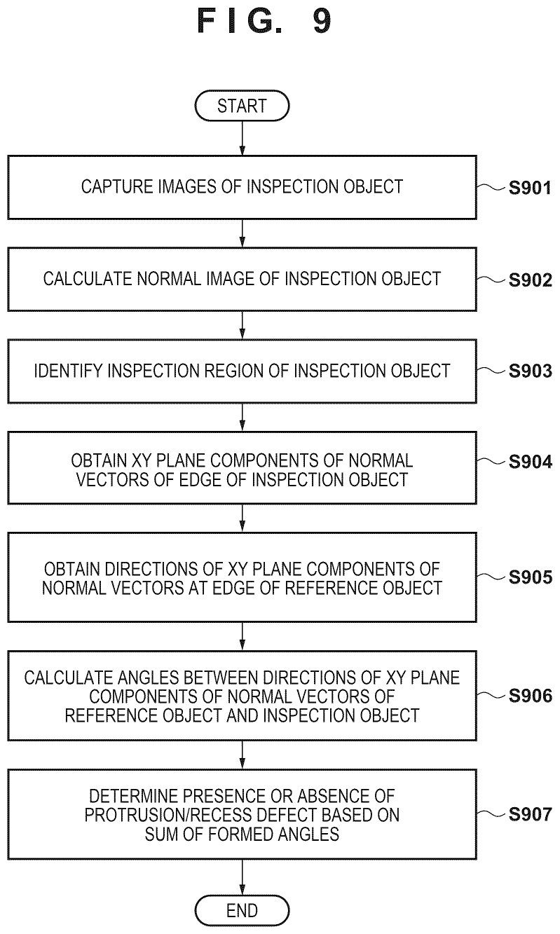

The processing performed to determine the presence or absence of a protrusion/recess defect, according to the system according to the present embodiment, will be described according to the flowchart of FIG. 9. In the present embodiment, the presence or absence of a protrusion/recess defect is determined based on a first projected vector nxy obtained by projecting a normal vector n of the inspection object onto the xy plane and a second projected vector n′xy obtained by projecting a normal vector n′ of the reference object onto the xy plane. Here, a reason for using the lengths of the projected vectors that are projected on the xy plane is to allow a difference in the slope of the inclined surface of the protruded/recessed shape. By ignoring the z component of a normal vector, for example, if the slope of the inclined surface of the protruded/recessed shape is the same in adjacent normal vectors, the lengths of the normal vectors projected onto the xy plane will be the same, and differences will not arise.

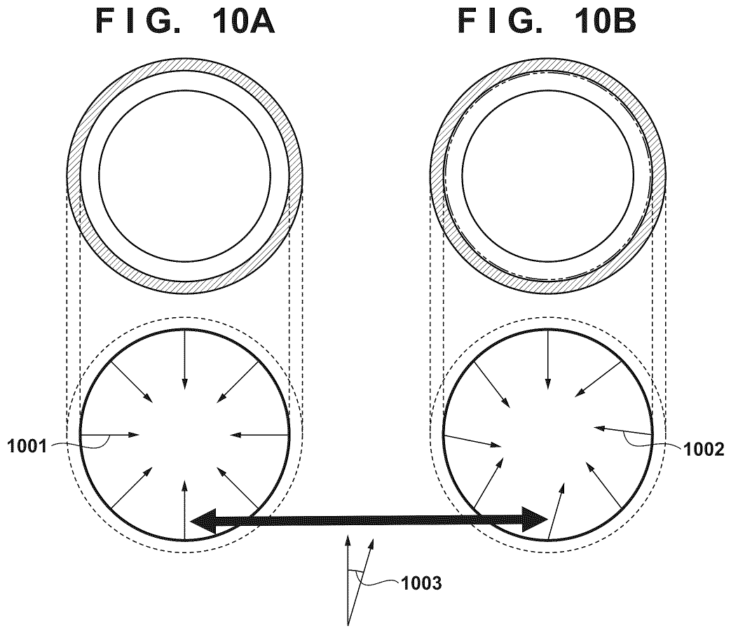

FIG. 10A is a plan view of a reference object and illustrates projected vectors n′xy 1001 obtained by projecting the normal vectors n′ at the edge of a container of the reference object onto the xy plane. Assuming that a non-defective product is used as the reference object, all of the projected vectors n′xy 1001 are directed toward the center of the container. This is because the shape of the edge is not wavy. In this example, a circular container is used, and so, all the projected vectors intersect at the center. If the container is square, projected vectors that are directed toward the center and orthogonal to the respective sides of the container intersect like a grid. As described above, a direction orthogonal to an edge of a container is determined irrespective of the shape of the container, and so, the shape of the container is not limited.

FIG. 10B is a plan view of an inspection object and illustrates projected vectors nxy 1002 obtained by projecting the normal vectors n at the edge of a container onto the xy plane. If a non-defective product is used as the inspection object, the projected vectors nxy will be orthogonal to the tangent of the boundary with the non-inspection region, and so, the projected vectors nxy will all be directed towards the center of the container. Meanwhile, if the inspection object is a defective product, the projected vectors nxy will be directed in various directions. FIG. 10B illustrates a case where the inspection object is a defective product as an example. This is due to the wavy shape of the edge, which determines the directions of the projected vectors.

In the present embodiment, the image processing apparatus 102 calculates an angle 1003 between the projected vector n′xy obtained by projecting the normal vector n′ at the container edge of the reference object onto the xy plane and the projected vector nxy obtained by projecting the normal vector n of the edge of the inspection object onto the xy plane. It can be said that the angle 1003 is a difference from a direction in which the projected vector obtained by projecting the normal vector of the inspection object onto the xy plane should be directed. Therefore, prior to inspecting a lot, the projected vectors n′xy of the above reference object need to be calculated and held as advance data. Therefore, in the present embodiment, the image processing apparatus 102 performs processing as in the first embodiment on the reference object and calculates the projected vector n′xy obtained by projecting the normal vectors n′ in the first inspection region of the reference object on the xy plane. Then, the image processing apparatus 102 stores the projected vectors n′xy calculated in advance in this way in the memory apparatus such as the storage apparatus 205.

The directions of the projected vectors n′xy do not depend on how a fluid poured for the reference object solidifies, and even if the slope of the inclined surface of the protruded/recessed shape is different, so long as the slope is constant, the projected vectors n′xy will be directed in the same direction, and so, there is an effect that it is possible to detect a protrusion/recess defect while allowing variation depending on the individual.

Steps S901 to S903 are processing similar to steps S401 to S403, respectively, and in step S904, the image processing apparatus 102 obtains the normal vectors n in the first inspection region of the inspection object as in step S404 described above. Further, in step S904, the projected vectors nxy obtained by projecting the normal vectors n onto xy plane are calculated as in step S405 described above.

In step S905, the image processing unit 1021 loads (obtains) the projected vectors n′xy, which have been calculated in advance and stored in a memory apparatus such as the storage apparatus 205, to the RAM 202.

In step S906, the image processing unit 1021 calculates, for each corresponding position θ, the angle 1003 formed by the projected vector n′xy obtained in step S905 and the projected vector nxy calculated in the processing of steps S901 to S904.

In step S907, the detection unit 1022 obtains the sum of the angles 1003 obtained for respective positions θ in step S906 and compares the magnitudes of the sum and a threshold. As a result of the magnitude comparison, the detection unit 1022, if the sum is greater than or equal to the threshold, determines that “there is a protrusion/recess defect (inspection object 204 is a defective product)” and, if the sum is less than the threshold, determines that “there is no protrusion/recess defect (inspection object 204 is a non-defective product)”. Then, the detection unit 1022 outputs a result of such determination. The output form is not limited to a specific output form.

Instead of the angle 1003, an inner product value of the projected vector n′xy and the projected vector nxy may be used. Thus, so long as the information represents a difference between the projected vector n′xy and the projected vector nxy, any information may be used in place of the angle 1003.

### Effects of Second Embodiment

As described above, in the present embodiment, if the projected vectors n′xy of the reference object obtained by projecting the normal vectors n′ onto the xy plane is obtained in advance, by comparing the normal vectors n of the inspection object with the projected vectors nxy that are projected onto the xy plane, it is possible to inspect a protrusion/recess defect at the edge of the container. Thus, it is possible to detect a protrusion/recess defect along the edge of the container while allowing the slope of the inclined surface along the edge to vary depending on the individual.

### Variation

In the following, a variation of the second embodiment will be described but in this variation, only differences from the second embodiment will be described, and unless otherwise mentioned, it is assumed that the variation is similar to the second embodiment. In the present variation, the coefficients of a spatial filter to be applied to the edge of the inspection object are determined according to the direction of the projected vector n′xy obtained by projecting the normal vector n′ of the reference object onto the xy plane. Therefore, as in the second embodiment, the projected vectors n′xy obtained by projecting the normal vectors n′ of the reference object onto the xy plane need to be obtained in advance. Then, by applying a spatial filter different for each position, the presence or absence of a protrusion/recess defect is determined.

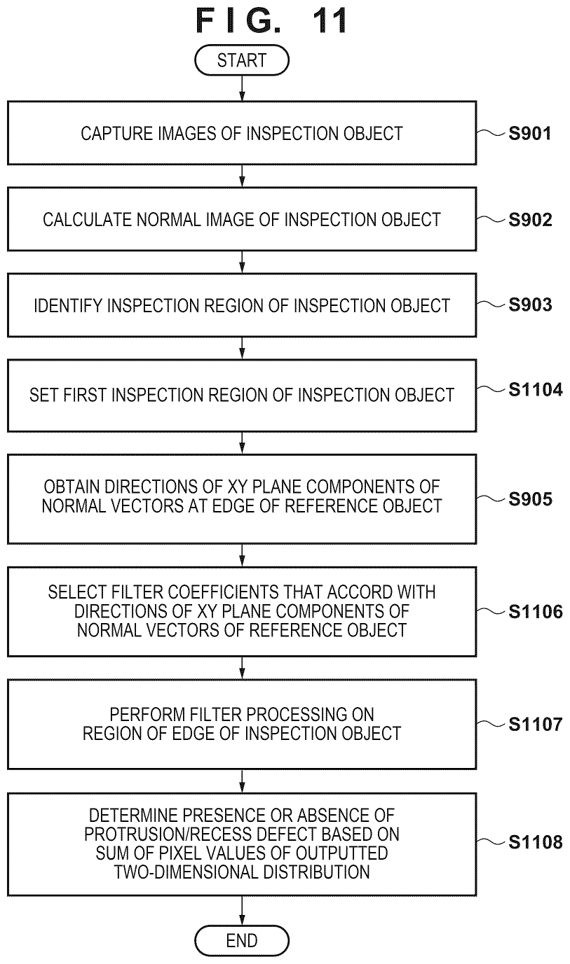

The processing performed to determine the presence or absence of a protrusion/recess defect, according to the system according to the present embodiment, will be described according to the flowchart of FIG. 11. In FIG. 11, the processing steps similar to the processing steps of FIG. 9 are denoted by the same step numerals, and the description pertaining to these processing steps will be omitted.

In step S1104, the detection unit 1022 sets the first inspection region as in the first embodiment in the normal image generated in step S902. In step S1106, the image processing unit 1021 selects, for each position θ on the first inspection region set in step S1104, “filter coefficients for edge detection” corresponding to the direction (e.g., angle from the x-axis) of the projected vector n′xy at the position θ.

The memory apparatus, such as the storage apparatus 205, stores in advance filter coefficients for spatial filters corresponding to various angles from the x-axis. Thus, by the start of processing of step S1106, the image processing unit 1021 loads the filter coefficients of the spatial filters corresponding to various angles from the x-axis to the RAM 202 from the memory apparatus such as the storage apparatus 205. Therefore, in step S1106, the image processing unit 1021 selects the filter coefficients corresponding to the direction of the projected vector n′xy at each position θ on the first inspection region set in step S1104 from the “filter coefficients of spatial filters corresponding to various angles from x-axis” loaded to the RAM 202.

This spatial filter is a spatial filter for detecting an edge in a direction orthogonal to the edge of the container. This is because if a spatial filter for detecting an edge in the direction along the edge of the container is used, the filter reacts to the slope itself of an inclined surface of the protruded/recessed shape at the edge of the container, and a defective phenomenon that should be captured ends up being buried in an output result. Therefore, it is necessary to change the direction in which the weights are concentrated according to the direction of a tangent of the boundary between the inspection region and the non-inspection region. For example, by the weights being substantially constant in the direction orthogonal to a tangent of the boundary, the slope of the inclined surface does not have an effect.

In step S1107, the detection unit 1022 generates a map obtained by converting component data of the first inspection region in the normal image of the inspection object into scalar values (e.g., length of a normal vector obtained from the respective x, y, and z components of the normal vector represented by the component data). Then, the detection unit 1022 performs convolution (filter processing) of a spatial filter having the filter coefficients selected in step S1106 for the position θ in the generated map. That is, the convolution of spatial filters is performed along the first inspection region. In the examples of FIGS. 3A to 3C, the detection unit 1022 performs a product-sum operation between a region, constituted by a pixel of interest in the line-shaped region 306 and pixels surrounding the pixel of interest, and the filter coefficients corresponding to the position θ of the pixel of interest. Then, the detection unit 1022 assumes the value obtained by the product-sum operation as a result of the filter processing at the pixel of interest.

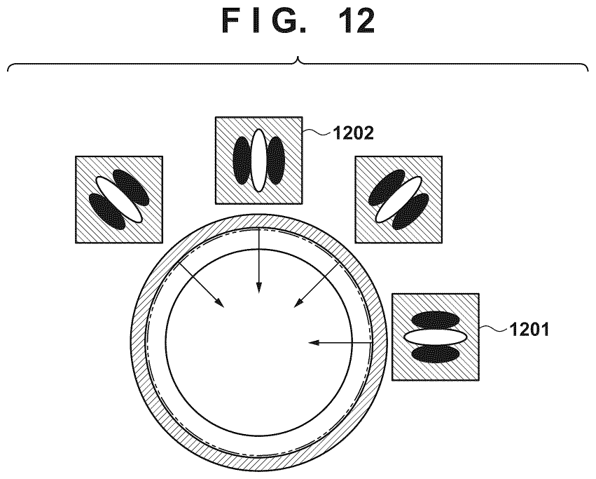

FIG. 12 illustrates how the spatial filters are applied. As illustrated in FIG. 12, if a center direction angle at the coordinates on the reference object is 180° (center direction is a left direction), a spatial filter for detecting a y-direction edge as indicated by reference numeral 1201 will be applied. Further, if the center direction angle at the coordinates on the reference object is 270° (center direction is a down direction), a spatial filter for detecting an x-direction edge as indicated by reference numeral 1202 will be applied.

Here, the edges are detected by using DoG filters, each adjusted to fit a protruded/recessed shape for which detection is to be performed. So long as a protrusion/recess defect can be detected, there is no limitation on the shape and coefficients of the filter. The processing as described above is performed once around the first inspection region of the edge of the inspection object.

In step S1108, the detection unit 1022 obtains the sum of values (values obtained by the above-described product-sum operation) at the respective pixel positions in the map obtained by the above-described filter processing and compares the magnitudes of the sum and a threshold. As a result of the magnitude comparison, the detection unit 1022, if the sum is greater than or equal to the threshold, determines that “there is a protrusion/recess defect (inspection object 204 is a defective product)” and, if the sum is less than the threshold, determines that “there is no protrusion/recess defect (inspection object 204 is a non-defective product)”. Then, the detection unit 1022 outputs a result of such determination. The output form is not limited to a specific output form.

Thus, according to the present variation, by performing convolution processing using spatial filters determined using the projected vectors n′xy obtained by projecting the normal vectors n′ of the reference object onto the xy plane, it is possible to determine the presence or absence of a protrusion/recess defect.

The numerical values, processing timing, processing order, processing entity, color space, data (information) obtainment method/transmission destination/transmission source/storage location, and the like used in each of the embodiments described above have been given as examples for the sake of providing a concrete explanation, and the present invention is not intended to be limited to such examples.

Further, some or all of the embodiments described above may be appropriately combined and used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
an obtaining unit configured to obtain a map representing a distribution of information related to protrusions and recesses based on a plurality of captured images obtained by imaging an inspection object; and
a determination unit configured to determine presence/absence of a protrusion/recess defect in a boundary portion between an inspection region and a non-inspection region in the map based on a uniformity of the information in the boundary portion.

2. The image processing apparatus according to claim 1, wherein the obtaining unit generates a first map representing a distribution of normal vectors based on the plurality of captured images.

3. The image processing apparatus according to claim 2, wherein the determination unit determines presence/absence of an outlier of angles of slopes based on the normal vectors of the boundary portion in the first map and, based on a result of that determination, determines presence or absence of a protrusion/recess defect in the boundary portion.

4. The image processing apparatus according to claim 3, wherein the determination unit determines presence or absence of an outlier of lengths of projected vectors obtained by projecting the normal vectors of the boundary portion in the first map onto a surface that is based on the inspection object and, based on a result of that determination, determines presence or absence of a protrusion/recess defect in the boundary portion.

5. The image processing apparatus according to claim 3, wherein the determination unit determines presence or absence of an outlier of lengths of projected vectors obtained by projecting the normal vectors of the boundary portion in the first map onto axes perpendicular to a surface that is based on the inspection object and, based on a result of that determination, determines presence or absence of a protrusion/recess defect in the boundary portion.

6. The image processing apparatus according to claim 2, wherein the obtaining unit generates a second map representing a distribution of normal vectors based on a plurality of captured images of a reference object, and
the determination unit determines presence or absence of a protrusion/recess defect in the boundary portion based on a difference between projected vectors obtained by projecting the normal vectors of the boundary portion in the first map onto a surface that is based on the inspection object and projected vectors obtained by projecting the normal vectors of the boundary portion in the second map onto the surface that is based on the inspection object.

7. The image processing apparatus according to claim 1, wherein the obtaining unit obtains a map representing a distribution of luminances at a surface that is based on the inspection object based on the plurality of captured images.

8. The image processing apparatus according to claim 7, wherein the determination unit determines presence or absence of an outlier of the luminances of the boundary portion in the map and, based on a result of that determination, determines presence or absence of a protrusion/recess defect in the boundary portion.

9. The image processing apparatus according to claim 1, wherein the determination unit determines, based on the uniformity of the information in a region that is not included in the boundary portion in the inspection region of the map, presence or absence of a protrusion/recess defect in that region.

10. The image processing apparatus according to claim 1, wherein the inspection object is an industrial product manufactured by solidifying content in a container, and
the plurality of captured images are captured images, each obtained by capturing the industrial product from a different position.

11. The image processing apparatus according to claim 10, wherein the boundary portion is included in an inclined surface of a protruded/recessed shape formed along an edge of the container due to interfacial tension between the content and the container.

12. The image processing apparatus according to claim 1, wherein the boundary portion is a region in which there is an inclined surface in a protruded shape formed by embossing or in a recessed shape formed by debossing.

13. The image processing apparatus according to claim 1, wherein the determination unit outputs a result of determination of presence or absence of a protrusion/recess defect in the boundary portion.

14. An image processing method executed by an image processing apparatus, the method comprising:
obtaining a map representing a distribution of information related to protrusions and recesses based on a plurality of captured images obtained by imaging an inspection object; and
determining presence/absence of a protrusion/recess defect in a boundary portion between an inspection region and a non-inspection region in the map based on a uniformity of the information in the boundary portion.

15. A non-transitory computer-readable storage medium storing a computer program that causes a computer to function as:
an obtaining unit configured to obtain a map representing a distribution of information related to protrusions and recesses based on a plurality of captured images obtained by imaging an inspection object; and
a determination unit configured to determine presence/absence of a protrusion/recess defect in a boundary portion between an inspection region and a non-inspection region in the map based on a uniformity of the information in the boundary portion.
